(19) United States
(12) Patent Application Publication
(10) Pub. No.: US 2015/0208625 A1
(43) Pub. Date: Jul. 30, 2015

(54) TWITCH DYNAMIC FISHING LURE

(71) Applicant: Robert Mann, Clearwater, FL (US)

(72) Inventor: Robert Mann, Clearwater, FL (US)

(21) Appl. No.: 14/608,885

(22) Filed: Jan. 29, 2015

Related U.S. Application Data
(60) Provisional application No. 61/933,329, filed on Jan. 30, 2014.
(60) Provisional application No. 62/031,227, filed on Jul. 31, 2014.
(60) Provisional application No. 62/036,398, filed on Aug. 12, 2014.
(60) Provisional application No. 62/072,456, filed on Oct. 30, 2014.

(51) Int. Cl. A01K 85/01; A01K 97/00

(52) U.S. Cl. CPC A01K 85/01; A01K 97/00

(57) ABSTRACT

A fishing lure representing a typical fish is formed from plastic or polymer. Embedded therein is provided a dynamic motion actuator utilized to attract fish by the continuous or random motion effected thereby. The device is powered by an onboard battery connected to a vibrational motor. Various alternative embodiments are provided. Amongst these one powers the lure using a cellphone stick battery supply having an electric wire socket to socket connection to a USB, circular socket or similar charging mechanism. Another has a door or screwed on cover that is removable and thereby operable to permit egress and ingress of used and replacement batteries respectively. The final embodiment is self contained as it is to be rechargeable via inductive principles.

### CROSS REFERENCE TO RELATED APPLICATIONS

This application claims the priority benefit of U.S. provisional patent application No. 61/933,329 filed on 30 Jan. 2014 herein incorporated by reference. This application claims the priority benefit of U.S. provisional patent application No. 62/031,227 filed on 31 Jul. 2014 herein incorporated by reference. This application claims the priority benefit of U.S. provisional patent application No. 62/036,398 filed on 12 Aug. 2014 herein incorporated by reference. This application claims the priority benefit of U.S. provisional patent application No. 62/072,456 filed on 30 Oct. 2014 herein incorporated by reference.

### FIELD OF THE INVENTION

The present invention relates to devices that attract fish by providing some form of stimulus. More particularly, the present invention relates to an electronic fishing lure having dynamic characteristics that sufficiently fool the target fish in to believing that the lure is an actual prey; this thereby compels the target fish to bite the lure entangling it in the associated fishing hooks.

### BACKGROUND OF THE INVENTION

### Vibration Motors

Small vibration motors have been around for several decades. They were originally developed for massaging products, but modern vibration motors rapidly expanded into the cellular phone market when consumers required vibrational alerts on their mobile phones. A typical cellphone vibration device has an eccentric mass attached to a motor, that is understandably known as an eccentric rotation masses (ERM) motors. Today, designers have learned from two decades of mobile phones how to make a variety of different types that have subsequently spread across a variety of technologies. Amongst these are miniature vibrating motors used in a wide range of products, like tools, scanners, medical instruments, GPS, and control sticks.

Enabling the motion of the device requires a suitable source of voltage and current. Because of this, ERM vibration motors are either directly connected to a voltage source or connected in series or parallel using a specifically designed control circuit such as a micro-controller chip on a circuit board, an IC circuit controller, a transistor based device, or other discrete glue logic devices accomplishing the appropriate control of ERM motor. All of these are within the level of the prior art.

### Current Fishing Lure Technology

Modern anglers have used two main techniques to attract fish to their hooks. Typically, a combination of live bait and an attractive colorful lure have been utilized to affect both the physical senses of sight and taste of the fish as it swims in the water. Lures come in various shapes and sizes ranging from flexible strips to hard plastic man made fish. This latter type typically is composed of two half shells shaped and colored as a typical fish; the two shells mirror one another and are attached along their innermost edges as is known in the art either through adhesives, glues, tongue and groove locking or arrowhead slot type of connection; various combinations of these attachment schemes are known in the prior art.

The use of these lures has proven somewhat effective overtime thereby having the intended effect of bringing a fish to clamp down its mouth onto a lure having associated hooks. However, fish are wild animals with great experience and can sometimes ignore a lure and bait; as a consequence, the wait to get a good animal snared can last a long time. Thus, there needs to be some device to effectively convince the fish that a live fish is present thereby exciting the target fish to aggressively attack the lure, live bait and or attached hooks. Additionally, there needs to be a solution that is efficient, inexpensive, easily manageable and portable.

### SUMMARY OF THE INVENTION

The present invention overcomes the deficiencies of the known art and the problems that remain unsolved by providing a novel Twitch Dynamic Fishing Lure.

A dynamic fishing lure comprising:
a fish structure having
an internally mounted vibrational motor in electric association with
a power source device mounted within the fish structure that is connected through an actuation device.
   In another aspect, wherein the actuation device further comprises:

a first wire connected to the power source device and extending outwards through the fish structure to an external space.

In another aspect, wherein the actuation device further comprises:

a second wire connected to the power source device and extending outwards through the fish structure to an external space.

In another aspect, wherein the power source device further comprises:

a removable battery replacement cover.

In another aspect, wherein the power source device further comprises:

a removable battery replacement compartment integrally formed from the fish structure.

In another aspect, wherein the power source device further comprises:

a permanent non removable battery.

In another aspect, wherein the power source device further comprises:

a USB port electrically connected to terminals of the lithium battery.

In another aspect, further comprising:

an LED device connected between a terminal of the vibration motor and the power source device.

In another aspect, wherein the actuation device further comprises:

an electro-mechanical push button switch.

A fishing lure comprising:

an aquatic animal bodily frame having

an internally mounted vibrational motor in electric association with

a power source device mounted within the aquatic animal bodily frame activating the vibrational motor through

an external open circuit lead extending through a perforation in the fish structure and that is connected to the power source device.

In another aspect, further comprising:

an LED device connected between a terminal of the vibration motor and the power source device.

In another aspect, wherein the power source device further comprises:

a removable battery replacement cover.

In another aspect, wherein the power source device further comprises:

a removable battery replacement compartment integrally formed from the fish structure.

In another aspect, wherein the power source device further comprises:

a USB port electrically connected to the power source device.

In another aspect, further comprising:

a second external open circuit lead extending through a perforation in the fish structure and that is connected to the vibrational motor.

In another aspect, wherein the first and second external open circuit leads are turned back on themselves forming a round hole at their ends.
In another aspect, wherein the first and second external open circuit leads are formed as a portion of a figure eight device.

A removable battery powered vibrational fishing lure comprising:

a fishing shell device having

a vibration motor mounted within it and connected to

removable battery pack.

In another aspect, further comprising:

a removable cover.

In another aspect, wherein the removable cover further comprises:

a twist off cap.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1A presents a circuit level diagram for a Twitch Dynamic Fishing Lure having an electromechanical switch that is to be loaded within the shells of a plastic or polymer fishing lure in an embodiment. FIG. 1B presents a circuit level diagram for a Twitch Dynamic Fishing Lure having an open circuit that is to be loaded within the shells of a plastic or polymer fish in another embodiment.

FIG. 1C presents a shell of fishing lure having a circuit level diagram for a Twitch Dynamic Fishing Lure having an electromechanical switch that is loaded within the shells of a plastic or polymer fishing lure in an embodiment. FIG. 1D presents a circuit level diagram for a Twitch Dynamic Fishing Lure having an open circuit progressing outside of the shells of the fishing lure; the circuit is loaded within the shells of a plastic or polymer fishing lure in this another embodiment.

FIG. 2 presents a component level diagram of various devices used to effect an embodiment of the Twitch Dynamic Fishing Lure having a electromechanical switch.

FIG. 3 presents a component level diagram of various devices used to effect a second embodiment of the Twitch Dynamic Fishing Lure having a removable battery pack and externally protruding open circuit.

FIG. 4 presents a component level diagram of various devices used to effect a third embodiment of the Twitch Dynamic Fishing Lure having a charging port and externally protruding open circuit.

FIG. 5 presents a component level diagram of various devices used to effect a fourth embodiment of the Twitch Dynamic Fishing Lure having a non-removable battery pack and externally protruding open circuit.

FIG. 6A presents an elevation view of a charging stick having a charging wire associated therewith. FIG. 6B presents an elevation view of a charger device having a charging wire associated therewith.

FIG. 7 presents various components describing a removable battery pack in the second embodiment of FIG. 3.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A fishing lure 1 as taught herein is a dual shell device shaped as a fish, other aquatic animals, or simple geometric shapes made from plastic, polymer, rubber or similar materials having various Twitch Dynamic Fishing Lure devices therein; these are designed to effect a compelling reaction on nearby aquatic life. The primary device within the lure is an eccentric rotating mass (ERM) appropriately mounted within internal walls on either or across both corresponding shell(s) having recesses (form fitting slots, tongue and groove support, arrowhead on one shell to a hole snap fittings on a corresponding one etcetera or combinations thereof) for attachment of the base portion of the ERM by itself using glues, compression, screws or the use of an associated circuit board upon which the ERM is solder mounted or otherwise attached thereto. The rest of the circuit portions are similarly mounted within the shells of the lure and wired together as necessary to provide power to the devices therein.

The fishing lures come in two main types, namely, a switch activated device and an open circuit water contact activated device. The first as its name implies is activated through a user toggling the motion of the eccentric rotating mass on and off. The second type on the other hand, is more ingenious in that the open circuit protrudes out the side of the shells and are normally external thereto; then a user deposits the lure within a body of water. As a result, the circuit is activated once both ends of the open circuit have made contact with water thereby completing the open circuit therethrough.

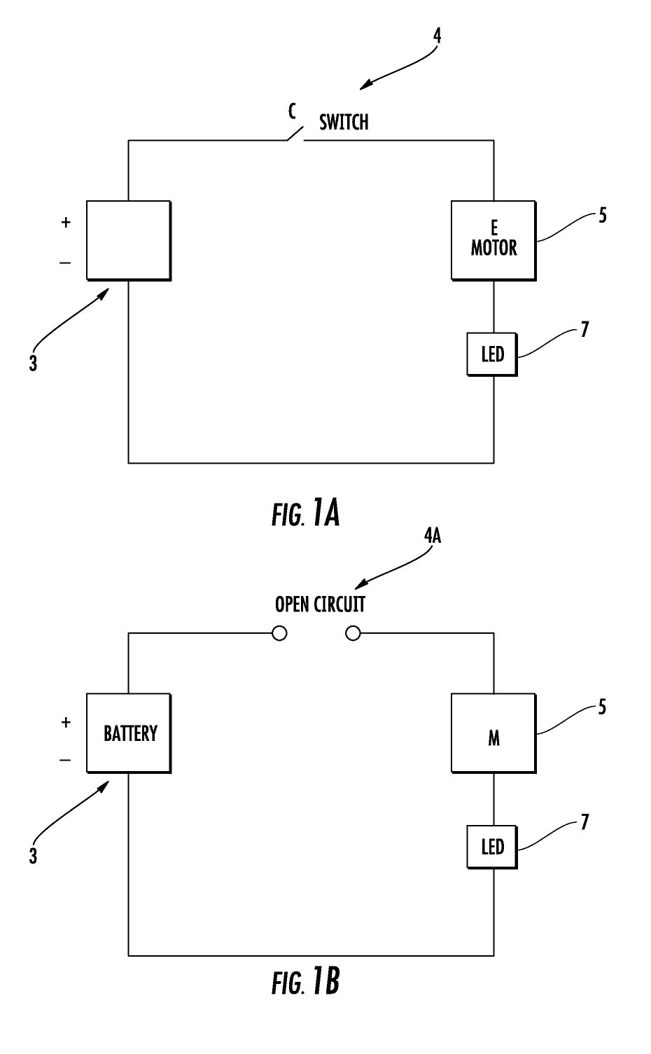

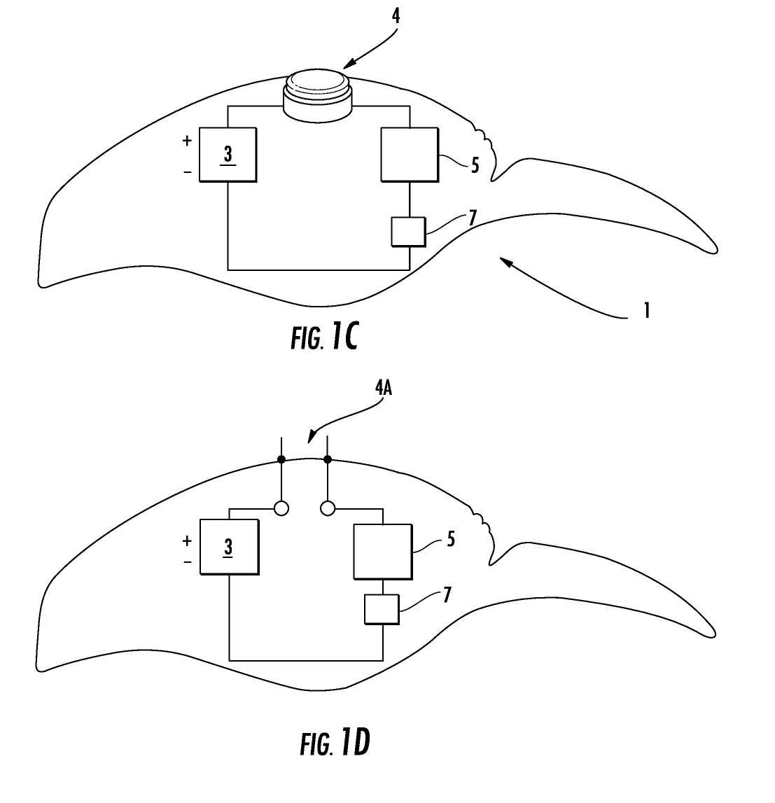

FIG. 1A presents a circuit level diagram for a Twitch Dynamic Fishing Lure having an electromechanical switch that is to be loaded within the shells of a plastic or polymer fishing lure in an embodiment. A terminal of a source of power such as a battery 3 or battery pack is connected to one end of a switching device 4 and its other terminal is connected to an optional LED device 7 at a contact thereof; alternatively, it is directly connected to the ERM motor 5. It should be understood that the switch 4 protrudes outside of the shell of the lure and the internal contents of the lure are sealed against water leakage using glues, gaskets, rubber seal and the like. Further, the other contact of the optional LED device is connected to the ERM motor 5 that has its other contact connected to the other contact of the switch 4. Thus, when a user toggles the switch ON to OFF he stops the motion of the motor and OFF to ON a user causes the ERM mass to energize thereby causing the lure to move about. Once placed in the water it is an effective attractor of aquatic life.

FIG. 1B presents a circuit level diagram for a Twitch Dynamic Fishing Lure having an open circuit that is to be loaded within the shells of a plastic or polymer fish in another embodiment. A terminal of a source of power such as a battery 3 or battery pack is connected to one end of an open circuit 4A and its other terminal is connected to an optional LED device 7 at a contact thereof; alternatively, it is directly connected to the ERM motor 5. It should be understood that the open circuit 4A contacts protrude outside of the shell of the lure and the internal contents of the lure are sealed against water leakage using glues, gaskets, rubber seal and the like. In the optional case, the other contact of the LED device is connected to the ERM motor 5 that has its other contact connected to the other contact of the open circuit 4A. Thus, when a user places the lure in the water, electric current circulates through the water between the two contacts of the open circuit 4A thereby causing the ERM mass to energize and the lure to move about creating an effective attractor of aquatic life.

FIG. 1C presents a shell of fishing lure having a circuit level diagram for a Twitch Dynamic Fishing Lure having an electromechanical switch that is loaded within the shells of a plastic or polymer fishing lure in an embodiment. Here the circuit of FIG. 1A is encapsulated within a dual shell fishing lure. An electromechanical push button switch 4 protrudes out of a hole in one of the shells of the lure or out of semi-circular holes in both shells that come together forming a single circular hole between the two shells; appropriate seals are provided to ensure that the internal contents of the lure are not contaminated by fluids.

FIG. 1D presents a circuit level diagram for a Twitch Dynamic Fishing Lure having an open circuit progressing outside of the shells of the fishing lure; the circuit is loaded within the shells of a plastic or polymer fishing lure in this another embodiment. Here the circuit of FIG. 1B is encapsulated within a dual shell fishing lure. Two contact wires protrude out the side of one shell or one each from each shell thereby forming an open circuit 4A; appropriate seals are provided about the wires to ensure that the internal contents of the lure are not contaminated by fluids. The wires are optionally turned back on themselves at their respective ends thereof thereby forming a round hole at each of their ends; this is to enable the attachment of fishing hooks within the aforementioned round holes; a variation of this has the wires formed as ‘figure eights’ as described below. Thus, it is envisioned that the wires are typically disposed underneath the lure for attachment of hooks thereon. However, the open circuit wires, figure eights or ends having round holes can be located anywhere on the body of the fishing lure that is deemed convenient.

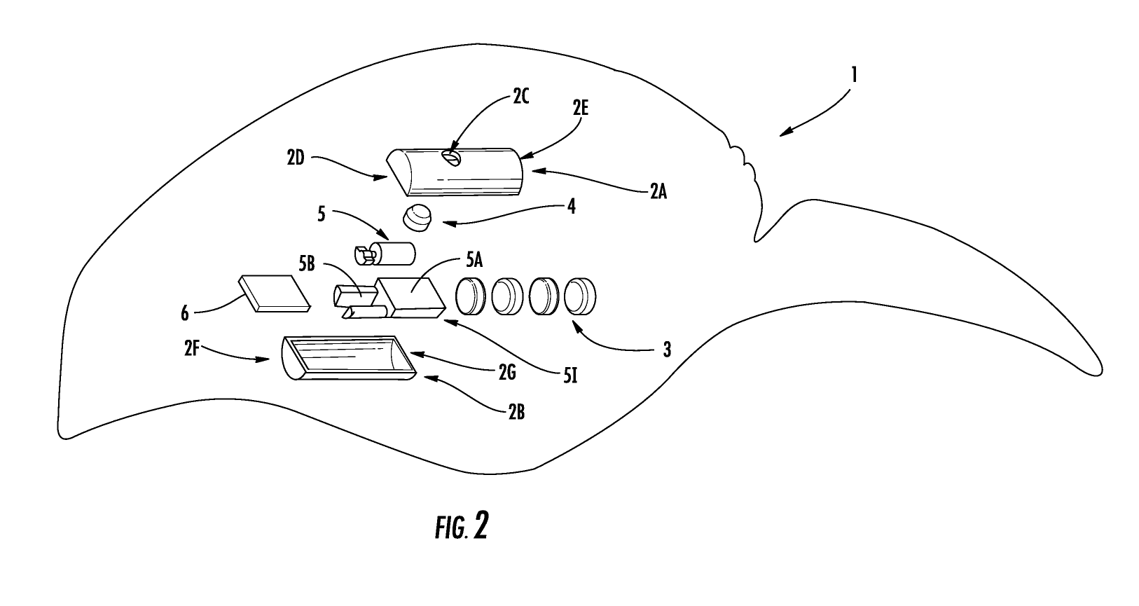

FIG. 2 presents a component level diagram of various devices used to effect an embodiment of the Twitch Dynamic Fishing Lure having an electromechanical switch. As previously described two half shells are molded in the shape of an aquatic animal or a simple geometric shape. Within this dual shell is another dual shell or ‘capsule’ holding the components of the Twitch Dynamic Fishing Lure; this is comprised of two half cylindrical plastic shells 2A, 2B. Item 2A is a half cylindrical shell having two semicircular ends 2D, 2E and a perforation or hole 2C approximately a quarter to half way down the top surface thereof for placement of a switch button 4 therein; the bottom edges of the circular half shell 2A forming the cylinder are shaped as a rectangle that matches a corresponding rectangle on item 2B. This item 2B is a half cylindrical shell having two semicircular ends 2F, 2G and whose top edges matches in size and shape the bottom edges of the first half shell 2A.

The design contemplates having a tongue and groove contact with an appropriate triangular protrusion (or other shape)/hole locking mechanism so that the two do not disengage or slide away from each other; alternatively, the shells are glued together or similar connection schemes are used whilst the particular details are not shown for simplicity in the drawing. Thus, a protrusion at one edge of item 2A, 2B matches a corresponding hole at an opposing side of item 2B, 2A. The tongue on one item would match a corresponding groove on the other item thereby completing the locking of the overall internal shell. In this way, a tongue and groove system binds the half shells 2A, 2B together. Alternatively, a mounting system is devised of internal walls within the fish 1 shells thereby holding the shells 2A, 2B in place through a flange on one engaging an inwards directed overhang on another.

A battery motor holder device 51 is a molded plastic component that fits within the cylindrical shells 2A, 2B such that the underside ‘portions’ thereof match the inner surface of item 2B; in other words, it 51 has a curved shape underneath. The battery motor holder device 51 has a square or rectangular battery compartment 5A space having a curved bottom inner surface at its anterior end for holding various disk shaped batteries 3; this compartment 5A is separate but integral with the rest of the device SI having both forward and rear semicircular internal walls integral with the rest of the overall device. It should also be understood that the compartment 5A has fixed positive and negative metallic contacts 5C, 5D (not shown) attached in slots at the forward and rear semicircular wall thereof. Further, 5E, 5F wires are welded to these contacts so as to provide electrical power to the rest of the Twitch Dynamic Fishing Lure.

The rear or posterior portion 5B of the battery motor holder device SI has two longitudinal parallel wings 5G, 5H that jut out therefrom; these wings have a semi circular shape externally and opposing circular shapes within forming a motor holder clamp therein. Thus, the back of the motor 5 that is of similar size is inserted within the two wings 5G, 5H and held therein snugly. The contact switch 4 sits above the motor 5 and has an external lip that extends outwards as a flange; this flange prevents the switch 4 from exiting through the hole 2C in the capsule shell 2A.

Providing electric power from the batteries to the rest of the circuit is accomplished by a wired circuit that communicates current from batteries 3 through the circuit when the switch 4 is in its ON position and prevents the same when in the OFF position. A wire is welded to to one terminal of a contact switch 4 and its opposite end is likewise welded to a terminal of the motor 5; the other terminal contact of the motor 5 is connected by wire to an optional circuit board 6 having an optional LED device soldered thereon; thus, the motor wire is welded/soldered to a terminal of the LED device. The optional circuit board 6 is loaded into a depression on the inner surface of the shell 2A and sits above the vibrational part of the motor 5.

In the event that the optional circuit board 6 is included, then another wire is welded to the other contact of the LED welded/soldered to the circuit board 6 and its opposite end is welded to the a terminal either of 5C, 5D of the battery holder 5A depending on the implementation. From there, another wire welded to the other terminal either of 5D, 5C has its opposite end welded to the contact switch's other terminal thereby completing the circuit. It should be understood that this motor 5 is an eccentric rotating mass type ERM motor (or similar vibration motor) that causes suitable vibration upon actuation of a push button switch 4 that sits atop the motor and is electrically connected thereto with suitably wiring. The switch is disposed to abut the non vibrational portion of the motor 5 thereby fixing it against the body thereof and the inside portion of shell 2A.

In the event that the circuit board 6 is excluded therefrom, the wire from the motor 5 that would have gone to the board 6 is instead extended to the battery compartment where it is welded to the other terminal contacts either of 5C, 5D of the battery holder 5A depending on the implementation. From there, another wire welded to the other terminal either of 5D, 5C has its opposite end welded to the contact switch's 4 other terminal thereby completing the circuit.

In this fashion it should be understood that this motor 5 is placed within the holder device SI posterior portion 5B behind the battery compartment 5A and separated therefrom. It should also be apparent that suitable wiring is included within the device to complete a DC circuit so as to energize the motor 5 when the push button 4 switch is turned ON; similarly, the internal nature of the switch 4 permits it being disconnected when it is turned OFF thereby cutting off electric power to the rest of the circuit. Appropriate optional internal mounts such as slots, grooves, walls are provided for the push button switch 4 and circuit card 6 but not shown for simplicity. It is also envisioned that a parallel circuit is also feasible according to circuit principles.

The assembled internal shell having the two half shells 2A, 2B form a ‘capsule’ and it and the contents thereof are placed within the confines of a plastic or polymer fish dual shell. The internal capsule composed of two half shells is optionally placed within internal mounts formed from internal plastic guides, protrusions, walls, grooves or other suitable shapes thereby fixing the position of the capsule so that it does not slide about within the volume of the fish. The external skin of the fish is similarly comprised of two outer shells that are locked together by a perimeter edge tongue and groove configuration; this is intended to permanently seal the package for later sale. Additionally, appropriate triangular protrusion—hole locking mechanisms so that the two outer shells do not disengage or slide away from each other are applied along the inner edges thereof. Optional rubber seals are applied along the inner and outer edges of the tongue and groove to prevent water from leaking therein. Glues and other materials such as rubber, nylon or other materials can be used to seal the device from water seepage.

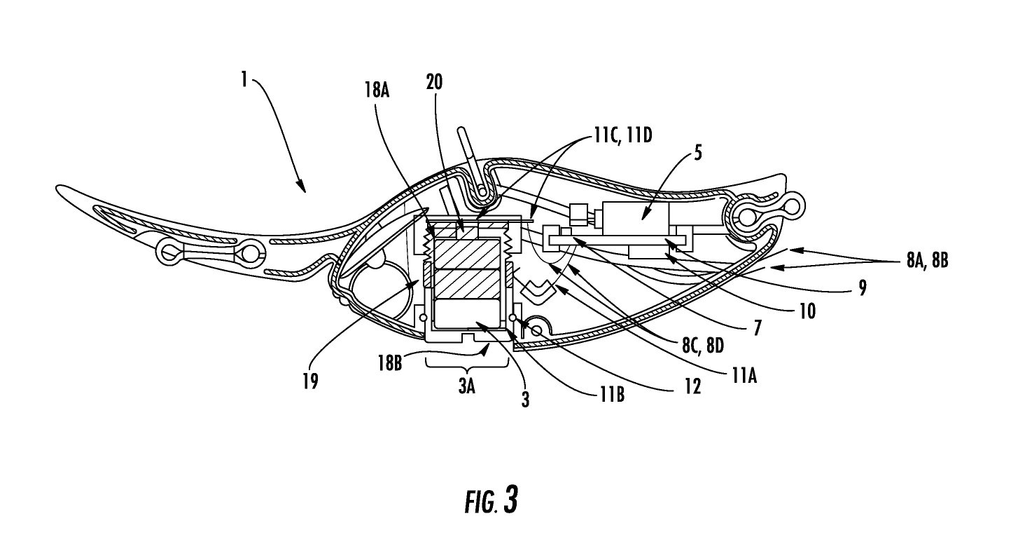

FIG. 3 presents a component level diagram of various devices used to effect a second embodiment of the Twitch Dynamic Fishing Lure having a removable battery pack and externally protruding open circuit. One half shell of a fishing lure 1 is described and the corresponding half shell is not shown for simplicity but it is understood. In this implementation, a circuit board 9 is mounted in two U shaped plastic protrusions that are integrally formed from plastic with the inner surface of the half shell; further, these U shaped protrusions are disposed opposite one another with the open center of the U shape facing one another thereby permitting a user to slide the circuit board in the protrusions. An electric vibration motor 5 and an LED light 7 are attached by soldering to the top surface of the circuit board 6 forming appropriate electric contacts thereon. A micro-controller, glue logic or an IC controller 10 is soldered to the bottom surface of the circuit board 6 forming appropriate electric contacts thereon. It should be understood that the circuit board can alternatively be replaced with wiring only.

Next, two conductive wires 8A, 8B are wired separately to the circuit board forming contact points thereon; the other extreme portion of the wires 8A, 8B extend outwards to the inner surface of the half shell forming the fishing lure 1 and through two small perforations in its wall and proceed on beyond the outside of the half shell of fishing lure 1; alternatively, the second wire 8B proceeds out the other half shell through a hole therein although not shown. The use of nylon in the plastic inner lining of the holes, a rubber gasket or glue helps prevent leakage of liquids from the outside to inner portion of the lure.

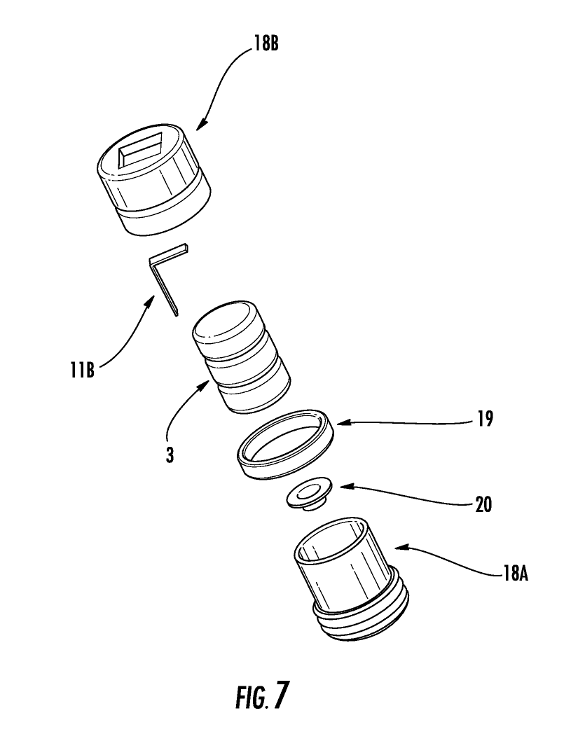

Next, a battery changing device 3A formed from cylindrical ends 18A, 18B batteries 3, and an O-ring is provided on the bottom portion of the shell disposed within a circular passageway formed integrally from the body of the shell. The O-ring is attached by adhesives or physical pressure into a circular depression running along the inner space of the passageway; it is meant to engage a similar depression on the cylindrical end 18B having the screw driver slot. It should be understood that this battery changing device 3A is in conformity with that described in FIG. 7 below; in particular, the user inserts a screw driver into a slot in the cylinder 18B and turns its head until it disengages from the bottom of the fishing lure. At this point a user can extract the batteries 3 therein and replace them with fresh ones; closing of the device by reattaching the cylinder 18B completes the process.

Providing electric power from the batteries 3 to the rest of the components is accomplished by a wired circuit that communicates current thereto; activation of this circuit is accomplished by a user placing the lure in an aquatic or liquid environment thereby providing a conductive channel for electric current to flow between the conductive wires 8A, 8B. Thus, when conductive wires 8A, 8B are in the water current can flow there between activating the motion of the Twitch Fishing Lure as well as an optional LED light; of course, no electric power flows when the device is not in the water as their is no conductive pathway to transfer current therethrough. Thus, an angler has a unique mechanism by which he or she can simply toss the Twitch Lure into the water immediately activating the visual and motion capabilities therein.

Conductive wires 8A, 8B each have an end that extends out through a perforation or hole in the side of shell in the lure 1 and another end that is welded to separate contact points on circuit board 9; alternatively, 8B extends out through the other shell. Then another wire 8C is soldered to the contact for 8A on the board 9 and its opposite end to a linear metal contact 11C that is inserted in a hole in a U shaped mounting platform internal and integral to the half shells; this U platform grips the top cylinder 18A using threads within the platform that match threads external to the cylinder 18A. A hole 11D in the cylinder 18A permits the metal contact 20 to extend out therefrom and meet the linear metal contact 11C terminal thereby connecting to the batteries therein.

The contact on the board 9 for wire 8B is connected to another wire soldered to a terminal of motor 5; the other terminal of the motor 5 is soldered to one terminal of an optional LED device itself soldered onto the circuit board 9 creating a contact point thereon. The other terminal of the LED device is soldered to circuit board 9 creating another contact point that has a wire 8D soldered thereto leading back to the metal ring 19 found in FIG. 7; an intermediate connection is made through an L shaped conductive metal 11A soldered to wire 8D that impacts the external surface of a conductive metal ring 19. This conductive metal ring 19 has electrical contact with the internal L shaped contact 11B that finally meets the other terminal of the batteries arrayed inside of the device 3A.

Finally, the activation of the motion of the ERM is engaged by at least two wires 8A, 8B that extend out of the shell(s) of the lure 1 or through the use of the metallic fishing hook holders in an alternative embodiment. In other words, the figure eight (8) shaped metal pieces (fishing hook holders) that extend out from the body of the lure and that are waterproof sealed are also used together as an alternative to the wire solution. Thus, one can have a solution with the two wires extending out from the shell(s) and another solution with the wires 8A, 8B instead of leaving the shell are connected to FIG. 8 holders connected in a open circuit configuration for water activation; the figure eight holders have round connection for the hooks integral with their bodies.

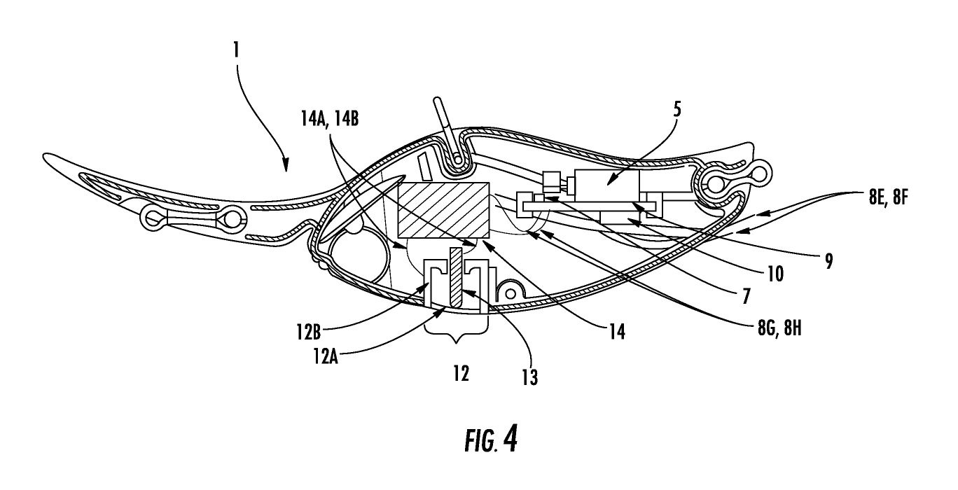

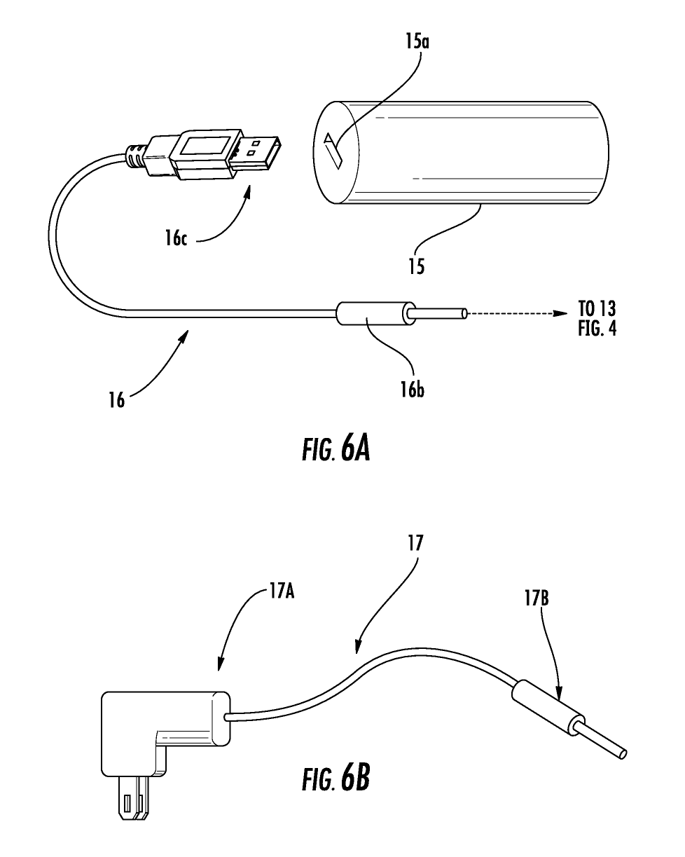

FIG. 4 presents a component level diagram of various devices used to effect a third embodiment of the Twitch Dynamic Fishing Lure having a charging port. In this embodiment, a Twitch Fishing Lure is shown having a recharging system such that the internal lithium rechargeable battery can be re-energized via an external source such as a cellphone stick device, a cellphone charger, a transformer device, a USB wire to a computer port or similar device such as those in FIG. 6A, 6B.

One half shell of a fishing lure 1 is described and its corresponding half shell is not shown for simplicity but it is understood. In this implementation, a circuit board 9 is mounted in two U shaped plastic protrusions that are integrally formed from plastic with the inner surface of the half shell; further, these protrusions are disposed opposite one another with the open center of the U shape facing one another thereby permitting a user to slide the circuit board in the protrusions. An electric vibration motor 5 and an LED light 7 are attached by soldering (welded) to the top surface of the circuit board 9 forming appropriate electric contacts thereon. A micro-controller or IC controller 10 is soldered (welded) to the bottom surface of the circuit board 9 forming appropriate electric contacts thereon.

Next, two conductive wires 8E, 8F are wired separately to the circuit board forming contact points thereon; the other extreme portion of the wires 8E, 8F extend outwards to the inner surface of the half shell and through small perforations in its wall on beyond the outside of shell; alternatively, the wires extend one out of the first half shell and the other out of the second half shell. The use of nylon in the plastic inner lining of the perforation, rubber gaskets or glue helps prevent leakage of liquids from the outside to inner portion of the shells.

A charging port 12 is provided on the bottom portion of the shell formed integrally from the body of the shell of the fishing lure or from the two shells together. The port 12 is shaped in the drawing as a U shaped however this could mean a rectangular shape for a USB type connection or a cylindrical shape for a typical round charging plug connector; a metallic contact layer 12B is attached within the U shape mimicking its internal shape; this is accomplished using detents from the integral U shape or similar modalities that grip the edges thereof or the prearranged perforations in the metallic contact layer.

A small sliding or flip on off cover 12A is formed at the neck of the port 12; the cover has thumb push grooves on its external surface to one side thereof and a small arrowhead protrusion underneath the thumb grooves extending beyond the edge of the cover 12A; this small arrowhead protrusion engages a hole in the internal surface of the neck of the port 12. The other side of the cover has a small rectangular protrusion that fits snugly into a hole in the neck of the port 12. Thus, the port 12 is embedded in the shell underneath a waterproof cover 12A that opens up to reveal it. Alternatively, a mechanism found in various cell phone charging ports is used whereby a small flap is attached to the outside of the phone.

The powering of the Rechargeable Twitch Lure is to now described with respect to the following. Providing electric power from the Lithium Battery 14 to the rest of the components is accomplished by a wired circuit that communicates current thereto; activation of this circuit is accomplished by a user placing the lure in an aquatic or liquid environment thereby providing a conductive channel for electric current to flow between the conductive wires 8E, 8F. Thus, when conductive wires 8E, 8F are in the water current can flow there between activating the motion of the Twitch Fishing Lure as well as an optional LED light; of course, no electric power flows when the device is not in the water as their is no conductive pathway to transfer current therethrough. Thus, an angler has a unique mechanism by which he or she can simply toss the Twitch Lure into the water immediately activating the visual and motion capabilities therein.

A conductive wire 8E has one end that extends out through a perforation or hole in the side of shell and another end that is welded to a contact on circuit board 9; then another wire 8G is soldered to that contact point and its opposite end to a terminal of the lithium battery 14. A second conductive wire 8F has one end that extends out through a perforation or hole in the side of shell and another end that is soldered to a contact point on circuit board 9; then another wire is soldered to that same contact on the board and its opposite end to a terminal of the motor 5; the other terminal of the motor 5 is soldered using another wire to an optional LED device terminal that has both of its terminals soldered onto the circuit board 9.

The other terminal of the LED device is soldered to circuit board 9 creating another contact point; this contact point has a wire 8H soldered thereto leading back to the other terminal of lithium battery 14. It should be understood that two wires 14A, 14B each connect to one terminal of the lithium battery and each likewise connect to one of the two terminals of port 12 thereby providing charging power to the rechargeable lithium battery there through. A first wire 14A is connected to the U shaped inner metallic contact layer 12B whilst a second wire 14B is connected to a central pin or connector 13 that is held within a hole in the top portion of the metal contact layer 12B and the integral U molded shape holding it; of course, there is no direct contact between metal contact layer 12B and the central pin or connector 13 as the two are protected by a plastic protrusion (the inner small shape adjacent the connector 13) of the integral U shape; alternatively, detents and perforations can be used with a I shaped plastic insert that separates them (connector/contact layer) electrically.

As an alternative to the above implementation a wire having a suitable port connector on one side and two alligator clips on the ends thereof provide power to a fishing lure having two external metal protrusions connecting to an internal power source. Another implementation envisions using suitable sockets for USB, Micro USB, Mini USB, charger port, transformer ports and similar such devices having contacts/wires to effect an electrical contact. These would continue on to the inside of the fish lure and make contact with the circuit in FIG. 4 about the battery as typical recharging would require.

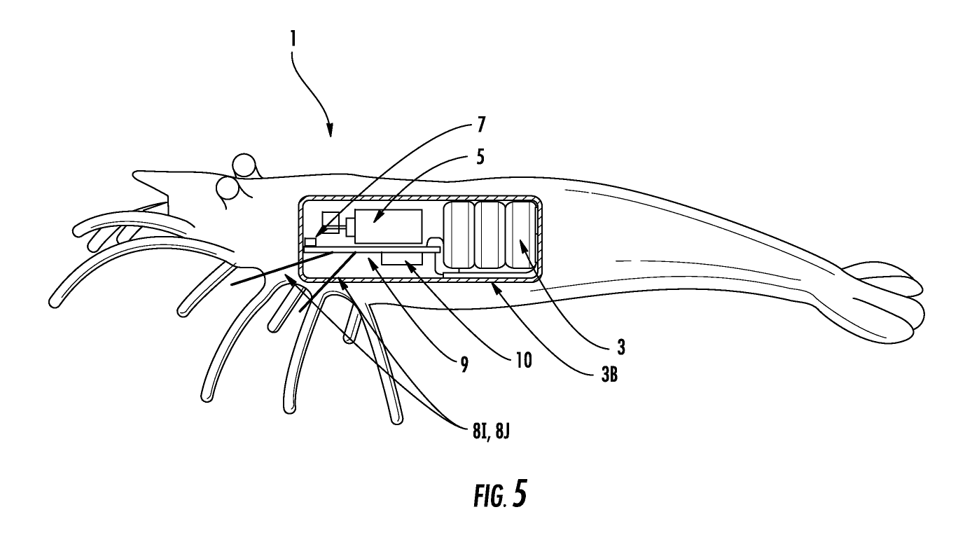

FIG. 5 presents a component level diagram of various devices used to effect a fourth embodiment of the Twitch Dynamic Fishing Lure having a non-removable battery pack and externally protruding open circuit. In this embodiment a plastic or polymer fishing lure 1 made from two external shells has embedded within it another dual shell container 3B that is completely enclosed at manufacture using a tongue/groove, protrusion/hole locking mechanisms and or glue. Within it are a set of disk shaped batteries 3 disposed posterior of a longitudinally arrayed circuit board 9 mounted within appropriately shaped walls therein (not shown for simplicity). Both the circuit board 9 and the batteries 3 have plastic spacers integrally formed from the interior surfaces of the dual shell container 3B so as to prevent them from disengaging therein.

An electric vibration motor 5 and an LED light 7 are attached by welding/soldering to the top surface of the circuit board 9 connecting their terminals as electric contacts to the board 9 and as described below. A micro-controller such as an IC controller 10 is welded/soldered to the bottom surface of the circuit board 9 forming appropriate electric contacts thereon. Next, two conductive wires 8I, 8J are connected separately to the bottom of circuit board 9 forming two contact points thereon; the other extreme portion of the wires 8I, 8J extend outwards and on through the enclosed shells 3B and into the external shells making up the lure 1 and beyond.

These proceed on through two small perforations in the enclosed internal shells 3B (one perforation each) and through two other small perforations in the external shells making up the fishing lure 1 and beyond the surface thereof. The use of nylon, rubber gasket(s) or glue helps prevent leakage of liquids from the outside to the inner portion of the fishing lure 1 or even on into the enclosed internal shells 3B at the location of these perforations.

The battery pack 3 in the shell 3B has a terminal connected by a conductor to the underside of the board 9 forming a contact point thereon; this contact point is further soldered to a wire on the board that connects to the contact point of one of the conductive wires 8I, 8J located on the bottom portion of the board. The other terminal of the battery pack 3 has a conductive wire that is soldered to the board 9 forming a contact point. This contact point is further wired (or soldered) to one terminal of an optional LED 7 (directly to motor 5 otherwise), also soldered to the board 9, whilst the other terminal of the LED 7 has its other terminal on the board connected by wire (or soldered) to a terminal of the vibration motor 5.

Next, the other terminal of the vibration motor 5 is connected to the other conductive wire's 8J, 8I contact that has been soldered to the bottom of the surface of the circuit board 9. It should be understood that the vibration motor 5 and the LED 7 can be interchanged in the circuit and that the LED 7 is an optional feature. Finally, micro-controller, IC controller 10 is either series or parallel connected between the LED 7 and the vibration motor 5 or across the vibration motor 5. Thus, a user has the option of a water activated Twitch Fishing Lure that is portable and attracts a great deal of attention as the motion of the body effectively simulates a fish.

FIG. 6A presents an elevation view of a charging stick having a charging wire associated therewith. A charging stick 15 is shown having a longitudinal body and a socket 15A for the insertion of a power adapter (USB, micro USB, mini USB) cable 16 having a first adapter 16C and another adapter shown as a round circuit adapter 16B integral therewith. These are useable to charge the Twitch Fishing lure in the embodiment of FIG. 4.

FIG. 6B presents an elevation view of a charger device having a charging wire associated therewith. A wire 17 has one end with a power adapter 17A or charger and the other end having a round adapter 17B. These are useable to charge the Twitch Fishing lure in the embodiment of FIG. 4.

FIG. 7 presents various components describing a removable battery pack in the second embodiment of FIG. 3; this view shows an isometric complete battery compartment assembly in an embodiment. There are essentially six components to make a completely operable battery compartment as taught herein; these are namely, a cylindrical end 18B having a flat head screw depression and a circular O ring depression about its external surface, a L shaped metal contact 11B, a set of three batteries 3, a metal external spacer ring 19, a round metal contact 20 having an integral flanged bottom portion, a plastic cylindrical end 18A having an external thread and circular hole for the round metal contact 20.

The entire device sits within a circular mount that is formed from the interior walls of both fish shells; that is it is formed half in one fish shell and half in the other fish shell; this half circular shape mount has matching threads for the thread found on the plastic cylindrical end 18A thereby ensuring that it does not disengage therefrom (shown in FIG. 3 more appropriately). Alternatively, it is formed transverse between the two fish shells and exits out one of them; this for the removable of the batteries using a flat head screw driver to remove 18B.

Power is provided through the negative portion of the batteries 3 that is in contact with a leg of the L shaped metal contact 11B; the other leg of 11B is in contact with the metal spacer ring 19. At this point wiring is provided that makes contact with other parts of the circuit as described in FIG. 3. Power is provided via the positive portion of the batteries 3 in physical contact with and through a round metal contact 20 that sticks through a hole in the plastic cylindrical end 18A. This round metal contact has a flange that prevents it from exiting through this hole in the plastic cylindrical end 18A.

Final Considerations:

Any of the herein embodiments having an open circuit water activation feature using externally extending wires can have the following alternative implementation. A figure eight (8) metal contact sits within the fishing lure and the other half sits outside of it for attachment of fishing hooks thereto (negative or positive wired connection to appropriate battery terminals or vice versa). The figure eight contacts are inserted within the shell of the fishing lure in a mounting region integrally formed from the internal space of the external shell(s) provided in one or both fishing shells to ensure that this structure does not move therein. The mounting regions described herein closely match the shapes therein and can be optionally sealed by rubber gaskets, adhesives or nylon seals as appropriate. In this fashion when a user throws the fishing lure in the water, electrical power is delivered via the two open circuit ends and through the water itself thereby activating the ERM motor and optionally any lights or other onboard devices.

Further the controller or IC control device taught in any embodiment herein is a typical Eccentric Rotating Mass controller or a custom designed one specific to the needs of the implementation. This may be substituted with a dedicated micro-controller, glue logic, circuit elements or combinations of the foregoing as appropriate.

It should be understood that various modifications of the teachings herein are contemplated and possible and that would still be within the breadth and scope of the appended claims. For example, a eccentric rotating mass motor is utilized as a primary vibrational motivator, however, any of the various other types of motors currently available can be utilized to perform the same effect and this would still be within the scope of the accompanying claims.

What is claimed is:

1. A dynamic fishing lure comprising:
a fish structure having
an internally mounted vibrational motor in electric association with
a power source device mounted within the fish structure that is connected through an actuation device.

2. The dynamic fishing lure of claim 1, wherein the actuation device further comprises:
a first wire connected to the power source device and extending outwards through the fish structure to an external space.

3. The dynamic fishing lure of claim 2, wherein the actuation device further comprises:
a second wire connected to the power source device and extending outwards through the fish structure to an external space.

4. The dynamic fishing lure of claim 1, wherein the power source device further comprises:
a removable battery replacement cover.

5. The dynamic fishing lure of claim 4, wherein the power source device further comprises:
a removable battery replacement compartment integrally formed from the fish structure.

6. The dynamic fishing lure of claim 1, wherein the power source device further comprises:
a permanent non removable battery.

7. The dynamic fishing lure of claim 6, wherein the power source device further comprises:
a USB port electrically connected to terminals of the lithium battery.

8. The dynamic fishing lure of claim 1, further comprising:
an LED device connected between a terminal of the vibration motor and the power source device.

9. The dynamic fishing lure of claim 1, wherein the actuation device further comprises:
an electro-mechanical push button switch.

10. A fishing lure comprising:
an aquatic animal bodily frame having
an internally mounted vibrational motor in electric association with
a power source device mounted within the aquatic animal bodily frame activating the vibrational motor through
an external open circuit lead extending through a perforation in the fish structure and that is connected to the power source device.

11. The dynamic fishing lure of claim 10, further comprising:
an LED device connected between a terminal of the vibration motor and the power source device.

12. The fishing lure of claim 10, wherein the power source device further comprises:
a removable battery replacement cover.

13. The fishing lure of claim 12, wherein the power source device further comprises:
a removable battery replacement compartment integrally formed from the fish structure.

14. The fishing lure of claim 10, wherein the power source device further comprises:
a USB port electrically connected to the power source device.

15. The fishing lure of claim 10, further comprising:
a second external open circuit lead extending through a perforation in the fish structure and that is connected to the vibrational motor.

16. The fishing lure of claim 15, wherein the first and second external open circuit leads are turned back on themselves forming a round hole at their ends.

17. The fishing lure of claim 15, wherein the first and second external open circuit leads are formed as a portion of a figure eight device.

18. A removable battery powered vibrational fishing lure comprising:
a fishing shell device having
a vibration motor mounted within it and connected to
removable battery pack.

19. The removable battery powered vibrational fishing lure of claim 18, further comprising:
a removable cover.

20. The removable battery powered vibrational fishing lure of claim 18, wherein the removable cover further comprises:
a twist off cap.
